(19) United States
(12) Patent Application Publication
(10) Pub. No.: US 2010/0186583 A1
(43) Pub. Date: Jul. 29, 2010

(54) Hollow double rod cylinder actuator

(75) Inventors: Joshua J. Loga, Eau Claire, WI (US); Thomas Frederick Meis, Eleva, WI (US); Daniel Thomas Meis, Eleva, WI (US)

Correspondence Address: RYAN KROMHOLZ & MANION, S.C., POST OFFICE BOX 26618, MILWAUKEE, WI, 53226, US

(73) Assignee: Jackson Lumber Harvester Company, Inc.

(21) Appl. No.: 12/322,084

(22) Filed: Jan. 28, 2009

(51) Int. Cl. F16J 7/00

(52) U.S. Cl. 92/110; 92/165 R

(57) ABSTRACT

A double hollow rod cylinder is provided. The cylinder includes a cylinder body and a piston apparatus.

The cylinder body has a hollow cylinder member with an internal cylinder cavity. The piston apparatus includes a piston, a first piston rod coupled to a first end of the piston and a second piston rod coupled to the second end of the piston. The piston apparatus is arranged such that the piston is within the cylinder cavity. The piston is fixed in place while the cylinder body is free to slide from a first position to a second position based on fluid input to the apparatus. A fluid system provides fluid to the first piston rod to move the cylinder body towards the free end of the first piston rod and fluid to the second piston rod to move the cylinder body towards the free end of the second piston rod.

### BACKGROUND OF THE INVENTION

This invention relates to an apparatus and method for moving a load. Specifically, the invention relates to an apparatus which utilizes a linear actuator, such as a cylinder actuator to move a load. Traditionally, such a system utilizes a stationary cylinder, a movable piston attached to a piston rod and a load coupled to the piston. The two sides of the piston are alternately pressurized and depressurized to achieve linear displacement of the piston and the load coupled to the piston. However, in order to provide a long stroke, in other words to move a load a long distance, a relatively large cylinder is needed. Because a relatively larger cylinder is utilized more fluid and power are needed to move the load.

It is desirable to provide an apparatus which can move a load a relatively long distance while utilizing a relatively small amount of fluid and power.

### SUMMARY OF THE INVENTION

The invention provides an apparatus and method for moving a load.

One aspect of the invention provides an apparatus including a piston apparatus having a first fluid inlet and a second fluid inlet, a cylinder body coupled to the piston apparatus, the cylinder body being slidable between a first position and a second position, means for sliding the cylinder body between a first position and a second position, and a load carrier coupled to the cylinder body.

In an additional embodiment the means for sliding the cylinder body further include a fluid source, a fluid pump, and a valve system, the valve system having an inlet coupled to an output of the fluid pump, a first output coupled to the first fluid inlet and a second output coupled to the second fluid inlet.

In an additional embodiment the piston apparatus further includes a piston having a first end and a second end, a first hollow piston rod having a first end and a second end, the second end being coupled to the first end of the piston, a second hollow piston rod having a first end and a second end, the first end being coupled to the second end of the piston. The first fluid inlet formed in the first piston rod near the first end thereof and the second fluid inlet located at the second end of the second piston body.

C apparatus includes at least one aperture extending through the first piston rod near the second end thereof and at least one aperture extending through the second piston rod near the first end thereof.

In an additional embodiment the cylinder body includes a hollow cylinder member having a first end and a second end, a first end cap coupled to the first end of the cylinder body, a second end cap coupled to the second end of the cylinder body and a cylinder mount disposed between the first end cap and the second end cap and coupled to the first end cap and the second end cap.

In an additional embodiment the apparatus includes a first bushing disposed within an aperture in the first end cap, the bushing being sized and configured to slidably engage the first piston rod and a second bushing disposed in an aperture in the second end cap, the bushing being sized and configured to slidably engage the second piston rod.

In an additional embodiment the apparatus includes at least one seal disposed between the first bushing and the first end cap and at least one seal disposed between the second bushing at the second end cap.

In an additional embodiment the apparatus includes at least one seal disposed between the piston and the cylinder member.

Another aspect of the invention provides a method including providing a cylinder body, the cylinder body including a generally hollow cylinder member having a first end and a second end, a first end cap coupled to the first cylinder member end, a second end cap coupled to the second cylinder member end, and a cylinder cavity within the cylinder member. The method further includes providing a piston apparatus, the piston apparatus including a piston having a first end and a second end; a first hollow piston rod having a first end and a second end coupled to the piston, the first piston rod having a first fluid inlet formed at the first end thereof; a second hollow piston rod having a first end coupled to the piston and a second end, the second piston rod having a second fluid inlet at the second end thereof. The method further includes the piston is disposed within the cylinder cavity, the piston dividing the cylinder cavity into a first section and a second section. The method further includes providing a fluid system, the fluid system having a fluid source in fluid communication with the first fluid inlet and the second fluid inlet. The method further includes moving the cylinder body in a first direction.

In one embodiment of the method the moving the cylinder body in a first direction step further includes providing fluid to the first fluid inlet.

In one embodiment the method further includes moving the cylinder body in a second direction.

In one embodiment of the method the moving the cylinder body in a second direction step further includes providing fluid to the second fluid inlet

In one embodiment of the method, the fluid system further comprises a fluid pump coupled to the fluid source and a valve system, the valve system having an inlet coupled to an output of the fluid pump, a first output coupled to the first fluid inlet and a second output coupled to the second fluid inlet.

In one embodiment of the method the fluid system is adapted to provide fluid selectively to either the first fluid inlet or the second fluid inlet.

### BRIEF DESCRIPTION OF THE DRAWINGS

FIG. 1 is a perspective view if an embodiment of a double rod cylinder according to the present invention.

FIG. 2 is the double rod cylinder of FIG. 1 with a portion cut out.

FIGS. 3 and 4 are a cross sectional view of the double rod cylinder of FIG. 1 mounted to a support with the cylinder body in its first position and second position respectively.

FIG. 5 is a diagrammatic view of the double rod cylinder of FIG. 1 including its control and fluid supply systems.

FIG. 6 is a perspective view of the double rod cylinder of FIG. 1 coupled to a plate to carry a load.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

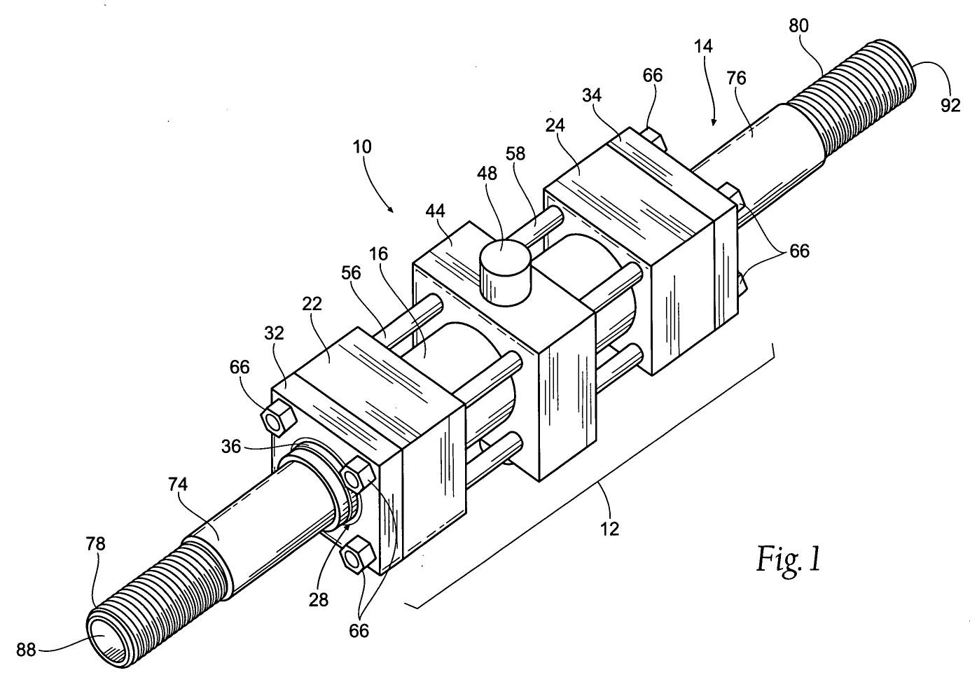

FIG. 1 shows an illustrated embodiment of a double hollow rod cylinder 10. The apparatus 10 preferably includes a cylinder body 12 and a double rod piston 14 slidably engaged with and extending through the cylinder body 12.

The cylinder body 12 preferably includes a hollow cylinder member 16. A cylinder cavity 30 is preferably formed inside the cylinder member 16. The cylinder member 16 has a first end 18 and a second end 20. A first end cap 22 is preferably coupled to the first end 18. A second end cap 24 is preferably coupled to the second end 20. Each end cap 22,24 preferably includes an aperture 26 extending therethrough.

The illustrated embodiment includes a retainer plate 32,34 associated with each end cap 22,24. Each retainer plate 32,34 preferably includes an aperture 28 extending therethrough. It is contemplated that the each retainer plate 32,34 may be a separate piece coupled to an end cap 22,24 or that the retainer plate 32,34 may be integrally formed with its respective end cap 22,24.

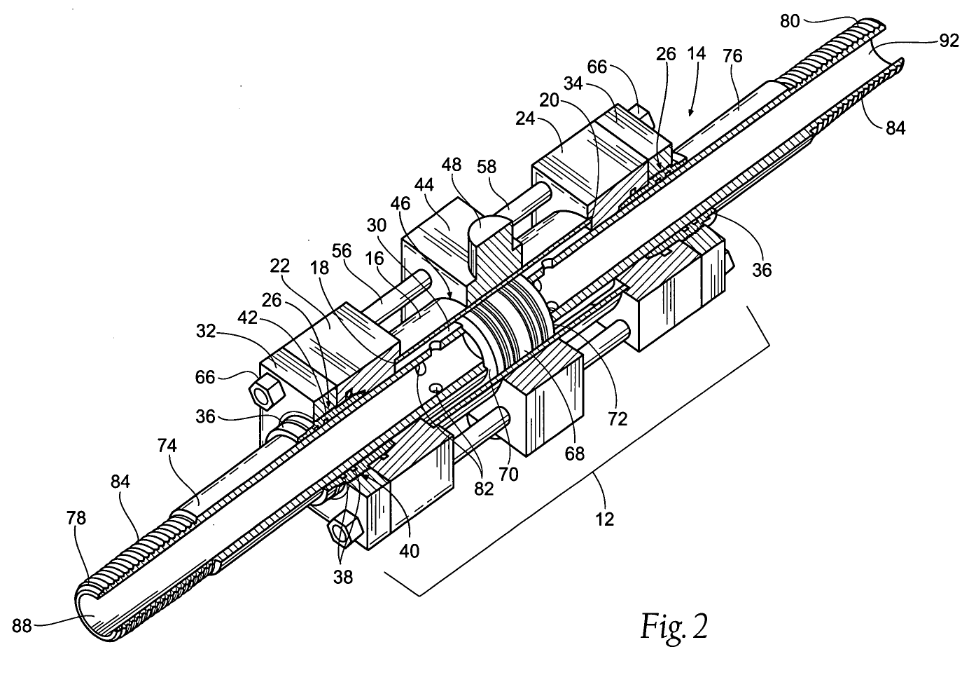

It is contemplated that a bushing 36 may be disposed the aperture 26,28 which extends through the end cap 22,24 and associated retainer plate 32,34 to reduce friction between each piston rod 74,76 and inner surface of the end cap 22,24 and retainer plate 32,34. It is further contemplated that the each bushing 36 may include at least one seal 38 to seal between the bushing 36 and a piston rod 74,76 and/or between the bushing 36 and the end cap 22,24. If desirable, as shown in FIG. 2, it is contemplated that each bushing 36 may be formed with threads 40 on the outside surface thereof. In such an arrangement, the interior surface of the retaining plate aperture 28 may also include threads 40.

In the illustrated embodiment the end caps 22,24 and retainer plates 32,34 have a generally rectangular cross section, however it is contemplated that the end caps 22,24 and retainer plates 32,34 may have other configurations, including, but not limited to, circular or cylindrical.

The cylinder body 12 preferably includes a cylinder mount 44. The cylinder mount 44 preferably includes an aperture 46 therethrough. The cylinder member 16 preferably extends through the cylinder mount aperture 46. The load to be moved is coupled to the cylinder mount 44 using any means known in the art.

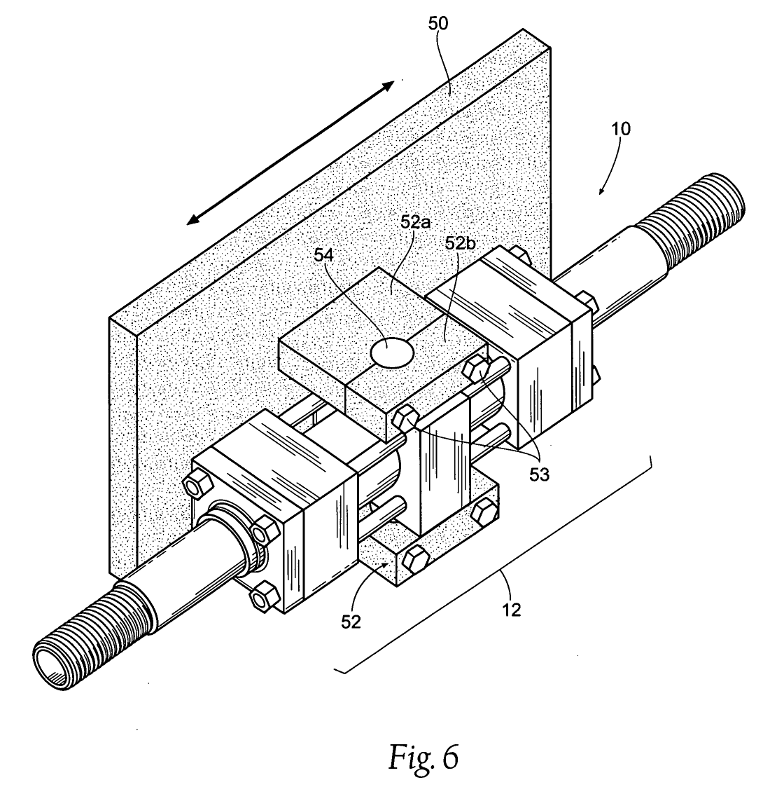

In the illustrated embodiment the load is coupled to the cylinder mount 44 using a trunnion mount. As shown in FIGS. 1 and 6, the cylinder mount 44 preferably includes at least one mounting projection 48. Preferably the cylinder mount 44 includes a pair of projections 48 located on a pair of opposed side surfaces, with one projection 48 extending from each of the pair of opposed side surfaces. The cylinder mount may be coupled to a load through a mounting plate 50 as shown in FIG. 6. The mounting plate 50 includes a pair of mounting arms 52, each mounting arm 52 having at least one aperture 54 extending therethrough. It is contemplated that each mounting arm may be made in two pieces 52a,52b which may be coupled together by at least one fixation member 53. The fixation member may take any form known in the art including, but not limited to, a screw. As shown in FIG. 6, it is contemplated that each portion 52a,52b of each mounting arm 52 may be formed with a partial aperture, such that when the two pieces 52a,52b are coupled to each other, the full aperture 54 is formed. The mounting arm apertures 54 are preferably sized and configured such that a first mounting arm aperture 54 matingly engages a first mounting projection 48 and a second mounting plate aperture 54 matingly engages a second mounting projection 48.

In the illustrated embodiment the cylinder mount 44 has a generally rectangular cross section, however it is contemplated that the cylinder mount 44 may have other configurations, including, but not limited to, circular or cylindrical.

The cylinder body 12 preferably includes at least one first tie rod 56 and one second tie rod 58. Preferably, each tie rod 56,58 has a threaded portion 60 at the first end and the second end thereof. At least one tie rod aperture 64 extends through each of the retainer plates 32,34, each of the end caps 22,24, and the cylinder mount 44. Although the cylinder mount 44 is described as having an aperture 64 therethrough is it further contemplated that the cylinder mount could have a first bore on the first side thereof and a second bore on the second side thereof. At least a portion of the cylinder mount tie rod aperture 60 preferably includes internal threads 62.

As seen in FIG. 2, each first tie rod 56 preferably extends through the first retainer plate 32 tie rod aperture 64, the first end cap 22 tie rod aperture 64, and is threaded into the first end of the cylinder mount 44 tie rod aperture 64. The second tie 58 rod preferably extends through the second retainer plate 34 tie rod aperture 64, the second end cap 24 tie rod aperture 64, and is threaded into the second end of the cylinder mount 44 tie rod aperture 64. Each tie rod 56,58 may be retained at its free end by any means known in the art. In the illustrated embodiment a retaining device 66 which may take the form of a nut is coupled to the free end of each tie rod 56,58 as shown in FIG. 2. In the illustrated embodiment four first tie rods 56 and four second tie rods 58 are utilized.

It is contemplated that the tie rods 56,58 may be solid or may be hollow. It is further contemplated that rather than a separate first tie rod 56 and a second tie rod 58, and integrated tie rod could be utilized. In such an embodiment the cylinder mount 44 would include an aperture 64 therethrough with a threaded portion 62 within the aperture 64 and the integrated tie rod would include a threaded portion located generally in the center of the tie rod. In this manner, an integrated tie rod could be threaded into the cylinder mount 44 with a first free end sized and configured to extend through the first retainer plate 32 and first end cap 22 and a second free end sized and configured to extend through the second retainer plate 34 and second end cap 24.

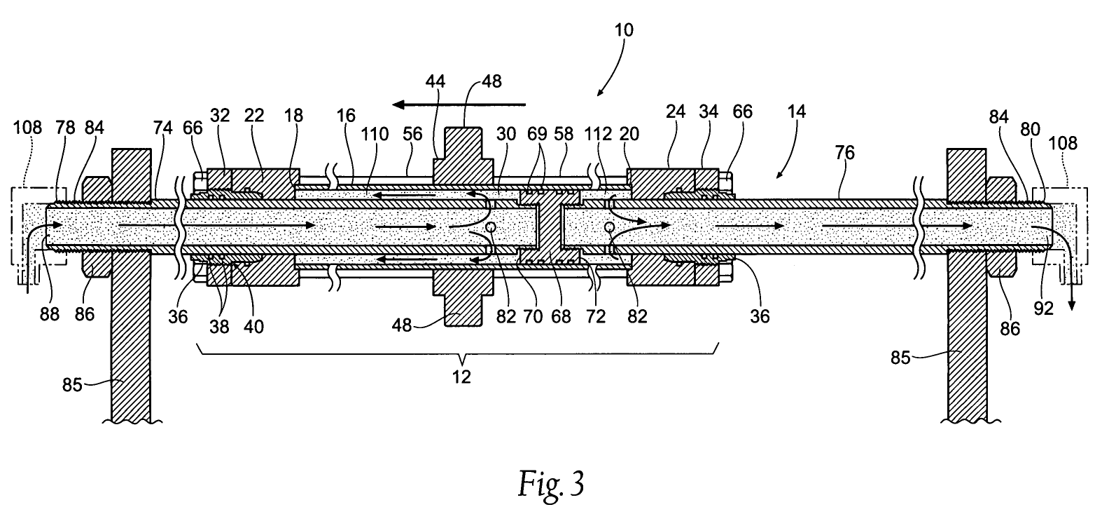

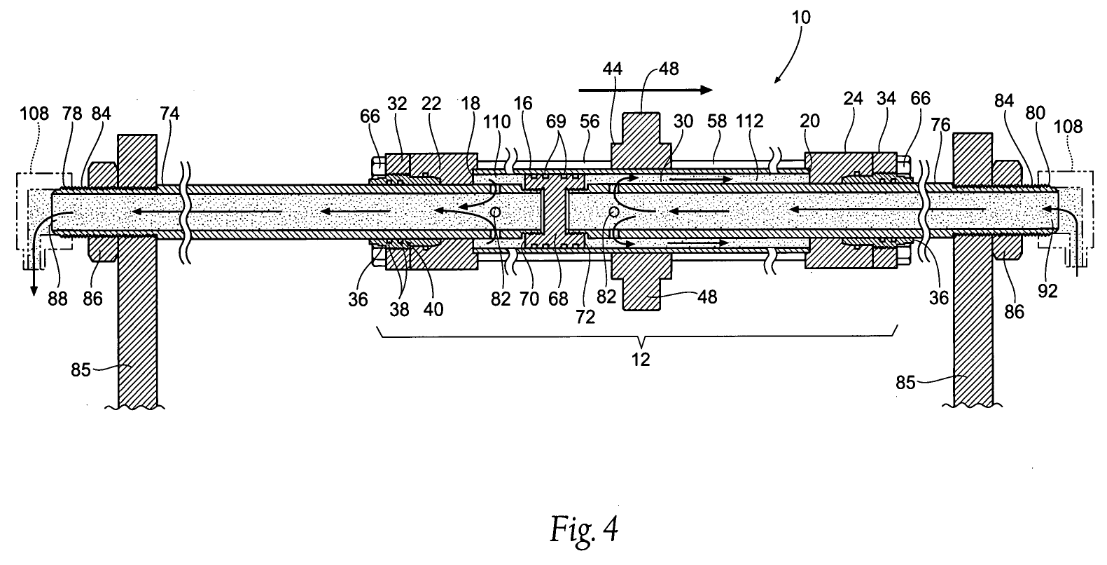

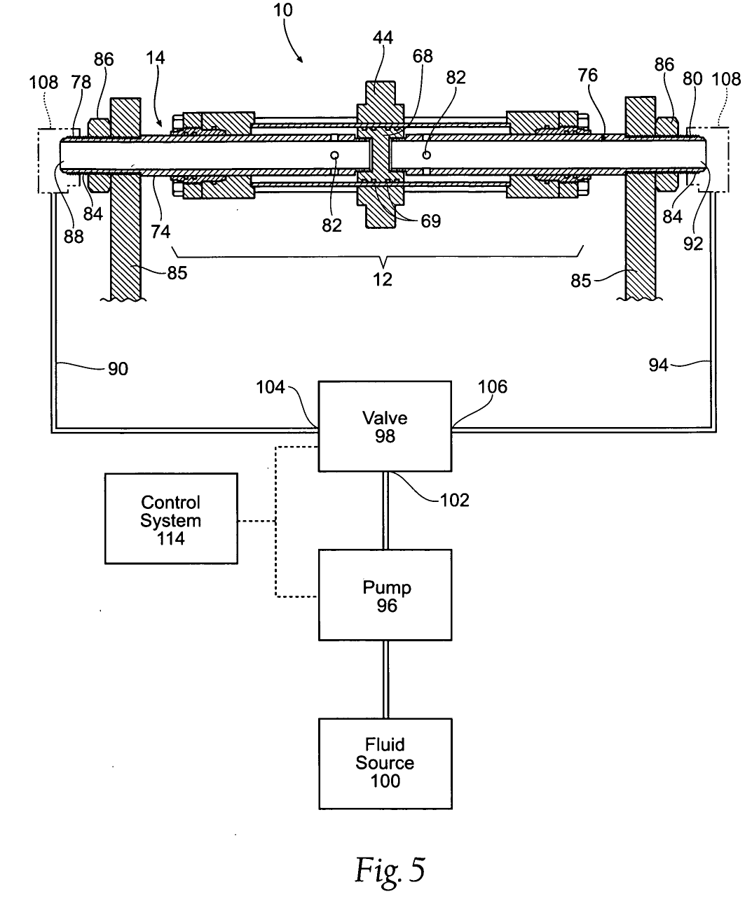

A double rod piston 14 is preferably disposed at least partially within the cylindrical body 12. As shown in FIG. 2, the double rod piston 14 preferably includes a piston 68 and a pair of hollow piston rods 74,76. The piston 68 is generally cylindrical in shape and is sized and configured to fit within the cylinder cavity 30. Preferably, the piston 68 includes at least one seal 69 to seal between the outside surface of the piston 68 and the inside surface of the cylinder member 16. The piston 68 divides the cylinder cavity 30 into a first portion 110 on the first side of the piston 68 and a second portion 112 on the second side of the piston 68. As shown in FIGS. 2, 3A and 3B, the size of the first portion 110 and the second portion 112 change as the piston 68 moves within the cylinder cavity 30.

The piston 68 preferably has a first end 70 and a second end 72. A first piston rod 74 is coupled to the first piston end 70. A second piston rod 76 is coupled to the second piston end 72. The free end 78 of the first piston rod 74 and the free end 80 of the second piston rod 76 extend out of the cylinder body 12. As shown in FIG. 2, the piston 68 is retained within the cylinder cavity 30 by the first end cap 22 and the second end cap 24. Both the first piston rod 74 and the second piston rod 76 include at least one fluid aperture 82 through the surface thereof. As shown in FIGS. 3A and 3B, the fluid apertures 82 are preferably arranged such that the fluid apertures 82 are located within the cylinder body 12 regardless of the position of the piston 68. For example, as shown in FIG. 3A, the fluid apertures 82 are adjacent the first end cap 22, however are still within the cylinder body 12.

Preferably, a threaded portion 84 is formed at the free end 78 of the first piston rod 74 and the free end 80 of the second piston rod 76. In this manner, the apparatus 10 may be mounted as shown in FIG. 1. It is contemplated that the apparatus 10 may be mounted using any means known in the art including, but not limited to securing the piston rods 74,76 to a mount 85 using a securing member 86 such as a threaded nut. In this manner, the double rod piston 14 is held in place while the cylinder body 12 is free to move.

In use, a fluid source 100 is coupled to the first fluid port 88 by a first fluid line 90. A fluid source 100 is coupled to the second port 92 by a second fluid line 94. The fluid lines 90,94 may be of any type known in the art. The fluid lines 90,94 may be coupled to their respective fluid ports 88,92 using any fluid connection fitting 108 known in the art. Preferably, a pump 96 is associated with the fluid source 100. A valve system 98 is preferably coupled to the output of the pump 96, the first fluid line 90 and the second fluid line 94.

The valve system 98 may take any form known in the art and is preferably adapted to shift the output of the pump 96 between the first fluid line 90 and the second fluid line 94.

For example, it is contemplated that the valve system 98 could take the form of a single three-way valve having a single input 102 and two outputs 104,106. In such a manner the pump 96 output is preferably coupled to the valve input 102, the first fluid line 90 is preferably coupled to the first valve output 104, and the second fluid line 94 is coupled to the second valve output 106.

It is further contemplated that the system could include two pumps (not shown), a first pump associated with the first fluid line to pump fluid from the source to the first fluid port and a second pump associated with the second fluid line to pump fluid from the source to the second fluid port. It is further contemplated that in such an embodiment two fluid sources (not shown) could be utilized with the first fluid source in fluid communication with the first pump and the second fluid source in fluid communication with the second pump.

To move the cylinder body 12 towards the free end 78 of the first piston rod 74, fluid is supplied to the first port 88. The fluid fills the first piston rod 74 and flows through the apertures 82 in the first piston rod 74 to fill the first portion 110 of the cylinder cavity 30. As fluid fills the first portion 110 of the cylinder cavity 30, the fluid pushes on the inside surface of the first end cap 22. The piston 68 seals the fluid from entering the second portion 112 of the cylinder cavity 30. The force of the fluid on the first end cap 22 moves the entire cylinder body 12 toward the free end 78 of the first piston rod 74. At the same time the second end cap 24 is moving closer to the piston 68 and fluid within the second portion 112 of the cylinder cavity 30 is being pushed out through the aperture 82 in the second piston rod 76 and out of the second fluid port 90.

To move the cylinder body 12 towards the free end 80 of the second piston rod 76, fluid is supplied to the second fluid port 92. The fluid fills the second piston rod 76 and flows through the apertures 82 in the second piston rod 76 to fill the second portion 112 of the cylinder cavity 30. As fluid fills the second portion 112 of the cylinder cavity 30, the fluid pushes on the inside surface of the second end cap 24. The piston 68 seals the fluid from entering the first portion 110 of the cylinder cavity 30. The force of the fluid on the second end cap 24 moves the entire cylinder body 12 toward the free end 80 of the second piston rod 76. At the same time the first end cap 22 is moving closer to the piston 68 and fluid within the first portion 110 of the cylinder cavity 30 is being pushed out through the apertures 82 in the first piston rod 76 and out of the first fluid port 88.

As is shown in FIGS. 3A and 3B, the movement of the cylinder body 12 in either direction is limited by the end caps 22,24. When the piston 68 engages an end cap 22,24, the cylinder body 12 cannot move any further in that direction.

In the illustrated embodiment, the cylinder body 12 carrying the load is moved while the piston 68 and piston rods 74,76 are held stationary. In this manner, the fluid lines 90,94 are also held stationary which may reduce wear on the fluid lines 90,94. It should be understood that because the fluid ports 88,92 either sides of the piston 68 are generally the same size and the first portion 110 and second portion 112 of the cylinder cavity 30 are generally the same size, the system 10 allows for equal flow of the fluid in both directions which provides for equal speed and equal thrust in both directions. It should also be understood that the working end of the rod 74,76 is always in tension, which may prevent buckling of the rod 74,76.

The system preferably includes a control system 114. Preferably, the valve system 98 and the pump 96 are operably connected to the control system 114. In this manner the control system 114 will control the operation of the pump 96 and the operation of the valve system 98 to control the input of fluid into the system 10 and therefore the motion of the cylinder body 12. It is contemplated that the apparatus 10 of the illustrated embodiment may be a component of a larger apparatus, and that therefore the control system 114 for the apparatus 10 of the illustrated embodiment may be incorporated into the control system for the larger apparatus.

It is contemplated that the system 10 could be actuated using any fluid known in the art including, but not limited to, air, oil, and water. While the fluid connections 108 in the illustrated embodiment are at the free end 78,80 of each piston rod 74,76, it is further contemplated that these connections 108 could be located along the surface of each piston rod 74,76 and could extend generally radially from each piston rod body 74,76. However, these fluid connections 108 are preferably located near the free end 78,80 of each piston rod 74,76 so that the fluid connections 108 and associated fluid lines 90,94 do not interfere with the motion of the cylinder body 12.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. An apparatus comprising:
a piston apparatus, the piston apparatus having a first fluid inlet and a second fluid inlet;
a cylinder body, the cylinder body being slidably coupled to the piston apparatus, the cylinder body being slidable between a first position and a second position;
means for sliding the cylinder body between a first position and a second position; and
a load carrier, the load carrier being coupled to the cylinder body.

2. The apparatus of claim one wherein the means for sliding the cylinder body further comprises
a fluid source;
a fluid pump; and
a valve system, the valve system having an inlet coupled to an output of the fluid pump, a first output coupled to the first fluid inlet and a second output coupled to the second fluid inlet.

3. The apparatus of claim 1 wherein the piston apparatus further comprises:
a piston, the piston having a first end and a second end;
a first piston rod, the first piston rod being generally hollow and having a first end and a second end, the second end being coupled to the first end of the piston;
a second piston rod, the second piston rod being generally hollow and having a first end and a second end, the first end being coupled to the second end of the piston; and
wherein the first fluid inlet being formed in the first piston rod near the first end thereof and the second fluid inlet is located at the second end of the second piston body

4. The apparatus of claim 3 further comprising
at least one aperture extending through the first piston rod near the second end thereof; and
at least one aperture extending through the second piston rod near the first end thereof.

5. The apparatus of claim 4 wherein the cylinder body further comprises:
a hollow cylinder member having a first end and a second end;
a first end cap coupled to the first end of the cylinder body;
a second end cap coupled to the second end of the cylinder body; and
a cylinder mount disposed between the first end cap and the second end cap and coupled to the first end cap and the second end cap.

6. The apparatus of claim 5 further comprising
a first bushing disposed within an aperture in the first end cap, the bushing being sized and configured to slidably engage the first piston rod; and
a second bushing disposed in an aperture in the second end cap, the bushing being sized and configured to slidably engage the second piston rod.

7. The apparatus of claim 6 further comprising
at least one seal disposed between the first bushing and the first end cap; and
at least one seal disposed between the second bushing at the second end cap.

8. The apparatus of claim 6 further comprising at least one seal disposed between the piston and the cylinder member.

9. A method comprising:
providing a cylinder body, the cylinder body including a generally hollow cylinder member having a first end and a second end, a first end cap coupled to the first cylinder member end, a second end cap coupled to the second cylinder member end, and a cylinder cavity within the cylinder member,
providing a piston apparatus, the piston apparatus including a piston having a first end and a second end; a first hollow piston rod having a first end and a second end coupled to the piston, the first piston rod having a first fluid inlet formed at the first end thereof; a second hollow piston rod having a first end coupled to the piston and a second end, the second piston rod having a second fluid inlet at the second end thereof;
wherein the piston is disposed within the cylinder cavity, the piston dividing the cylinder cavity into a first section and a second section;
providing a fluid system, the fluid system having a fluid source in fluid communication with the first fluid inlet and the second fluid inlet; and
moving the cylinder body in a first direction.

10. The method of claim 9 wherein the moving the cylinder body in a first direction step further comprises providing fluid to the first fluid inlet.

11. The method of claim 10 further comprising
moving the cylinder body in a second direction

12. The method of claim 11 wherein the moving the cylinder body in a second direction step further comprises providing fluid to the second fluid inlet

13. The method of claim 12 wherein the fluid system further comprises
a fluid pump coupled to the fluid source; and
a valve system, the valve system having an inlet coupled to an output of the fluid pump, a first output coupled to the first fluid inlet and a second output coupled to the second fluid inlet.

14. The method of claim 13 wherein the fluid system is adapted to provide fluid selectively to either the first fluid inlet or the second fluid inlet.
